(19) United States
(12) Patent Application Publication
(10) Pub. No.: US 2020/0167525 A1
(43) Pub. Date: May 28, 2020

(54) SYSTEMS AND METHODS FOR WORD FILTERING IN LANGUAGE MODELS

(71) Applicant: 3M INNOVATIVE PROPERTIES COMPANY, St. Paul, MN (US)

(72) Inventors: Richard H. Wolniewicz, Longmont, CO (US); Kelly S. Peterson, Salt Lake City, UT (US)

(21) Appl. No.: 16/619,800

(22) PCT Filed: Jun. 1, 2018
(86) PCT No.: PCT/IB2018/053955

§ 371 Date: Dec. 5, 2019

Related U.S. Application Data
(60) Provisional application No. 62/516,934, filed on Jun. 8, 2017.

(51) Int. Cl. G06F 40/284; G06F 40/242; G06F 16/93

(52) U.S. Cl. CPC G06F 40/284; G06F 16/93; G06F 40/242

(57) ABSTRACT

At least some aspects of the present disclosure direct to a system having one or more processors and memories for word filtering. The one or more memories are configured to store a plurality of documents; and store a domain dictionary. The one or more processors are configured to generate a set of tokens for each of the plurality of documents and separate the set of tokens into a subset of dictionary tokens and a subset of non-dictionary tokens using the domain dictionary; The one or more processors are further configured to filter the subset of non-dictionary tokens to produce a subset of filtered non-dictionary tokens, where each of the filtered non-dictionary tokens has an occurrence frequency greater than a predefined threshold.

### TECHNICAL FIELD

At least some aspects of the present disclosure are related to word filtering systems and methods used with language models.

### BACKGROUND

Recent advances in distributed language models (e.g. “word embedding”) have allowed researchers to build systems which are able to learn significant relationships between words (e.g. “man” is to “boy” as “woman” is to “girl”) from large amounts of unlabeled and unstructured text. Language models include, for example, word representation models, unigram language models, n-gram models, and the like. These models can be used for a number of different tasks including sentiment analysis, entity recognition, topic model, and many more. These models are used in a variety fields of business, such as healthcare, finance, customer relations, and others.

### SUMMARY

At least some aspects of the present disclosure direct to a method of word filtering implemented on a system having one or more processors and memories. The method comprises the steps of: receiving a plurality of documents; receiving a domain dictionary; generating, by the one or more processors, a set of tokens for each of the plurality of documents, each token representing a meaningful segment in the document; separating, by the one or more processors, the set of tokens into a subset of dictionary tokens and a subset of non-dictionary tokens, wherein each of the subset of dictionary tokens is in the domain dictionary, and wherein each of the subset of non-dictionary tokens is not in the domain dictionary; filtering, by the one or more processors, the subset of non-dictionary tokens to produce a subset of filtered non-dictionary tokens, wherein each of the filtered non-dictionary tokens has an occurrence frequency greater than a predefined threshold; and generating, by the one or more processors, a set of filtered tokens, wherein the set of filtered tokens comprises the subset of dictionary tokens and the subset of filtered non-dictionary tokens.

At least some aspects of the present disclosure direct to a system having one or more processors and memories for word filtering. The one or more memories are configured to store a plurality of document; and store a domain dictionary. The one or more processors are configured to: generate a set of tokens for each of the plurality of documents, each token representing a meaningful segment in the document; separate the set of tokens into a subset of dictionary tokens and a subset of non-dictionary tokens, wherein each of the subset of dictionary tokens is in the domain dictionary, and wherein each of the subset of non-dictionary tokens is not in the domain dictionary; filter the subset of non-dictionary tokens to produce a subset of filtered non-dictionary tokens, wherein each of the filtered non-dictionary tokens has an occurrence frequency greater than a predefined threshold; and generate a set of filtered tokens, wherein the set of filtered tokens comprises the subset of dictionary tokens and the subset of filtered non-dictionary tokens.

### BRIEF DESCRIPTION OF DRAWINGS

The accompanying drawings are incorporated in and constitute a part of this specification and, together with the description, explain the advantages and principles of the invention. In the drawings,

FIG. 1 is a system diagram of one embodiment of a word filtering system;

FIG. 2A illustrates a flowchart of one embodiment of a word filtering system;

FIG. 2B illustrates a flowchart to an embodiment of evaluating occurrence frequency for tokens;

FIG. 3 illustrates an example flowchart of a PMA engine implementing the algorithm; and

FIGS. 4A and 4B illustrate one example of a word filtering system with some example data.

In the drawings, like reference numerals indicate like elements. While the above-identified drawings, which may not be drawn to scale, set forth various embodiments of the present disclosure, other embodiments are also contemplated, as noted in the Detailed Description. In all cases, this disclosure describes the presently disclosed disclosure by way of representation of exemplary embodiments and not by express limitations. It should be understood that numerous other modifications and embodiments can be devised by those skilled in the art, which fall within the scope and spirit of this disclosure.

### DETAILED DESCRIPTION

While language models hold tremendous opportunity for applications, in some cases, these models could potentially be reverse engineered to gain knowledge about sensitive information. For example, in some circumstances, such a model could be used to determine that a particular healthcare patient was assigned a particular diagnosis or that a customer owns certain products. Such situation may be undesirable as a model outcome, and may even be a violation of some regulation, such as HIPAA in the case of patient data. Therefore, at least some aspects of the present disclosure direct to a technique to ensure that sensitive information (e.g., personal identifiable information) are removed from a dataset so that they will not be used to generate a language model. With such a technique, the resulting model can be considered to be free of sensitive information and could then be used in wider applications or even possibly distributed to other research groups.

The functions, algorithms, and methodologies described herein may be implemented in software in one embodiment. The software may consist of computer executable instructions stored on computer readable media or computer readable storage device such as one or more non-transitory memories or other type of hardware based storage devices, either local or networked. Further, such functions correspond to modules, which may be software, hardware, firmware or any combination thereof. Multiple functions may be performed in one or more modules as desired, and the embodiments described are merely examples. The software may be executed on a digital signal processor, ASIC, microprocessor, or other type of processor operating on a computer system, such as a personal computer, server or other computer system, turning such computer system into a specifically programmed machine.

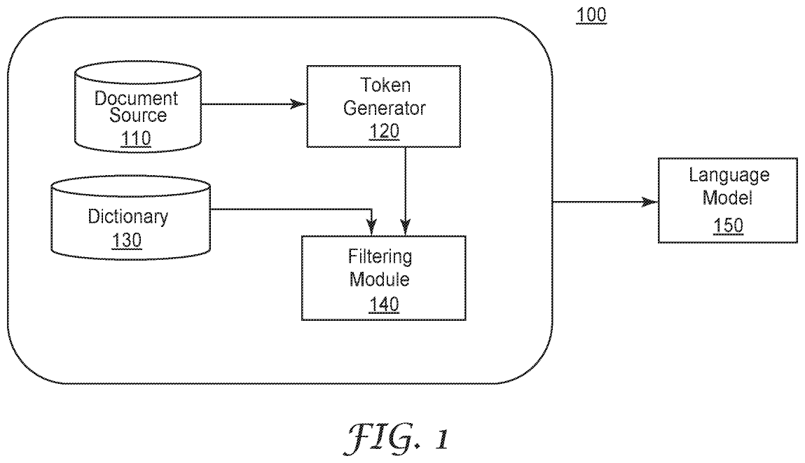

FIG. 1 is a system diagram of one embodiment of a word filtering system 100. The word filtering system 100 includes a document source 110, a token generator 120, a dictionary 130, and a filtering module 140. The document source 110 stores a number of documents. The token generator 120 analyzes the documents and generate a set of tokens for each of the documents. The dictionary 130 is an optional component of the system and includes one or more domain dictionaries, for example, a medical dictionary for healthcare or some lexicon of products and features for consumer data. The filtering module 140 uses the information in the dictionary 130 and/or other methodologies to generate a set of filtered tokens. The word filtering system 100 provides the set of filtered tokens to the language model 150.

The document source 110 can be any data repository storing a number of documents, including, for example, a plurality of files, a relational database, a multidimensional database, object store system, and the like.

The token generator 120 analyzes the documents and generates a set of tokens, each token represents a word, a portion of a word, a non-word element, or a phrase of one or more words. In some embodiments, the tokens are linguistic units separated out from the documents, such as “right arm”, “Mary”, “purchase”, “2003”, etc. In some embodiments, the token generator 120 includes methodology to address abbreviations, punctuations, etc. In some implementations, the token generator 120 employs an adaptive approach to extract phrases.

The dictionary 130 may include one or more domain dictionaries. For example, the dictionary 130 may include a medical dictionary having medical terminology, such as, disease names, medications, medical procedures, body parts, health conditions, and so on. As another example, the dictionary 130 may include a finance dictionary having finance glossary, such as economic terms, accounting terms, business terms, financial analysis terms, and the like. In yet another example, the dictionary 130 may include a product dictionary for a field having product terminology specific to the field, for example, plumbing products, apparel market, etc.

The filtering module 140 may include one or more components to filter the tokens generated by the token generator 120 to reduce or eliminate sensitive data. In one embodiment, the filtering module 140 uses the dictionary 130 and generates a set of dictionary tokens and a set of non-dictionary tokens. In one embodiment, the filter module 140 further processes the set of non-dictionary tokens using a filter algorithm and generate a subset of filtered non-dictionary tokens, and then generate a set of filtered tokens including the set of dictionary tokens and the subset of the filtered non-dictionary tokens. In some embodiments, the filtering module 140 may use a document matching algorithm to identify a set of documents from a matching source such that the tokens generated from the set of documents should be bundled in the filtering process. For example, a set of documents from a matching source can be a set of documents from a same person. As another example, a set of documents from a matching source can be documents from a same facility (e.g., a clinic, a hospital, etc.).

The language model 150 can be implemented using one or more existing language models, for example, a word embedding model, a word representation model, a statistical language model, a unigram language model, an n-gram model, or the like. In one embodiment, a word embedding model maps words and phrases to vectors of real numbers. In some implementations, methodologies such as neural network, deep machine learning, probabilistic modeling, and the like, are used to generate the mapping from words to vectors. For example, Word2Vec is a word embedding model employing neural networks in the modeling. The Word2Vec model is described in Mikolov et al., Distributed representations of words and phrases and their compositionality, NIPS'13 Proceedings of the 26th International Conference on Neural Information Processing Systems, Pages 3111-3119, 2013; and Levy et al., Improving Distributional Similarity with Lessons Learned from Word Embeddings, Transactions of the Association for Computational Linguistics, 2015, the entirety of which are incorporated herein by reference.

Various components of the word filtering system 100 and the language model 150 can be implemented by one or more computing devices, including but not limited to, circuits, a computer, a processor, a processing unit, a microprocessor, and/or a tablet computer. In some cases, various components of the word filtering system 100 can be implemented on a shared computing device. Alternatively, a component of the system 100 and/or the language model 150 can be implemented on multiple computing devices. In some implementations, various modules and components of the system 100 can be implemented as software, hardware, firmware, or a combination thereof. In some cases, various components of the word filtering system 100 can be implemented in software, software application, or firmware executed by a computing device.

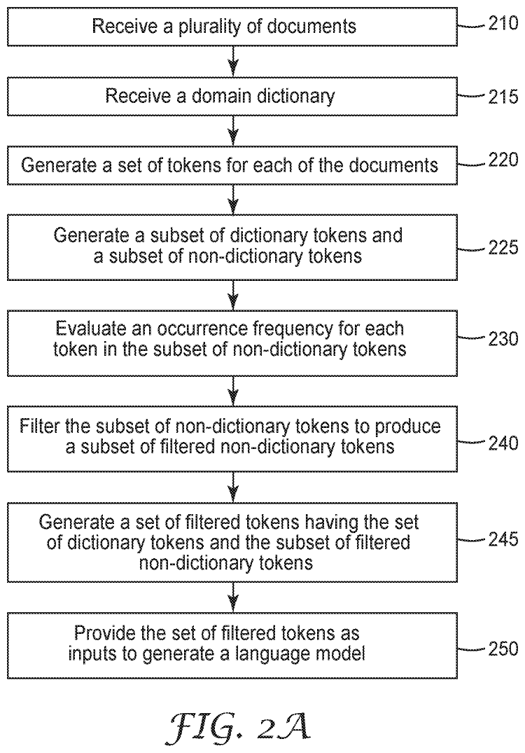

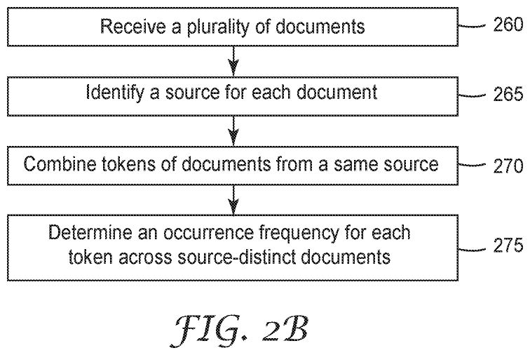

FIG. 2A illustrates a flowchart of one embodiment of a word filtering system. One or more steps in the flowchart are optional steps. First, the system receives a plurality of documents (step 210). A document used herein can be a digital file, a data record, or the like. The system receives a domain dictionary (step 215). The system generates a set of tokens for each document (step 220), for example, using the token generator. Using the domain dictionary, the system generates a subset of dictionary tokens, where each of the dictionary token is in the dictionary, and a subset of non-dictionary tokens, where each of non-dictionary tokens is not in the domain dictionary (step 225). Next, the system evaluates an occurrence frequency for each token in the subset of non-dictionary tokens (step 230). The system filters the subset of non-dictionary tokens to produce a subset of filtered non-dictionary tokens, wherein each of the filtered non-dictionary tokens has an occurrence frequency greater than a predefined frequency threshold (step 240). The system generates a set of filtered tokens, which comprises the subset of dictionary tokens and the subset of filtered non-dictionary tokens (step 245). The set of filtered tokens can be provided as inputs to generate a language model (step 250).

FIG. 2B illustrates a flowchart to an embodiment of evaluating occurrence frequency for tokens. First, the system receives a plurality of documents (step 260). Next the system identifies a source for each of the plurality of documents (step 265). The system combines tokens of documents from a matching source (step 270). The system determines an occurrence frequency for each token across source-distinct documents (step 275), where source-distinct documents refer to documents having different sources. The occurrence frequency of a token across source-distinct documents refers to the number of occurrence of the token in documents with different sources, where occurrence(s) of the token is counted as one (1) for documents with a matched source.

In some embodiments, the source of a document can be determined using a known key of the data, for example, a medical record number, a matching address, a social security number, and the like. In some cases, one or more computational algorithms, for example, such as probably matching, regression model, and the like, can be used in the determination of a source of a document. The occurrence frequencys of tokens are then calculated in consideration of the source of the document. For example, if a token appears five (5) times in one document, the occurrence frequency of the token is one (1); if a token appears two (2) times in Document A of Source I and three (3) times in Document B of Source I, the occurrence frequency of the token is one (1); and if a token appears two (2) times in Document A of Source I and three (3) times in Document C of Source II, the occurrence frequency of the token is two (2).

In some embodiments, the word filtering system uses one or more algorithms to identify the sources of documents, such that the system can combine documents from the matching sources when evaluating occurrence frequency and removing low frequency tokens that are likely to be sensitive information. For example, if a person's last name is unique within a dataset, the person's last name can be used to identify the person and sensitive information; contrarily, the last name of “Smith” is likely to occur in many documents and not to be identifiable information. Here, it is not desirable to remove all proper names from the data, because some of the names are used in disease or procedure names, such as “Parkinson”. In some embodiments, the filtering methodology includes a person match algorithm (PMA) to identify and combine documents of the same person. This step can be important because the word filtering system needs to determine sensitive information that has low frequency in the dataset such that the sensitive information can be used to identify the associated person.

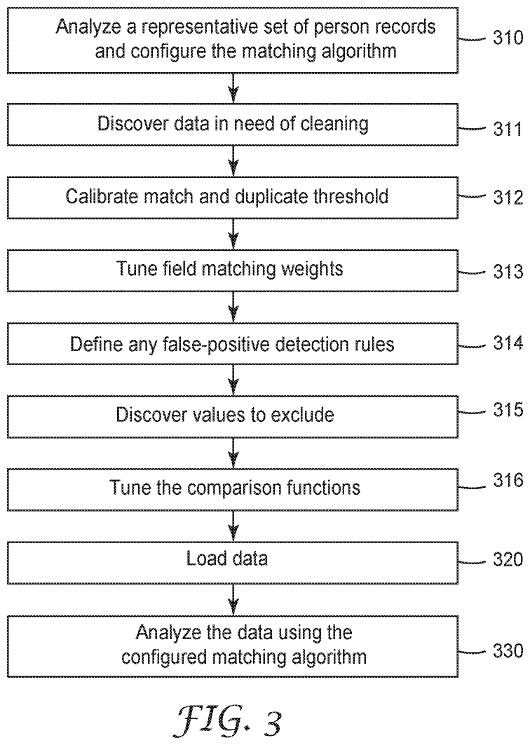

In some embodiments, the PMA algorithms are attuned to the specific characteristics of the data population. Person records are given composite weights and thresholds. In one example, a person's records to be used for matching include the following: first name, last name, middle initial, address, address history, aliases, email, managed identifier, phone numbers, phone number history, races, and the like. FIG. 3 illustrates an example flowchart of a PMA engine implementing the algorithm. First, the engine analyzes a representative set of patient records and configure the matching algorithm (step 310). For example, the PMA engine analyze the data source to identify patterns, frequencies, weights, and exclusions. Within this step, in one embodiment, the engine will performance one or more of the steps: Discover data in need of cleaning (step 311); Calibrate match and duplicate thresholds (step 312); Tune field matching weights (step 313), for example, tuning the matching weight of last names; Define any necessary false-positive detection rules, such as “Liz” and “Elizabeth” can be equivalent (step 314); Discover values to exclude (step 315); and Tune the comparison functions (step 316). In some cases, a default value or a dummy value can be excluded. For example, a default date of birth of ‘01/01/01’ and the data ‘Unknown’ or ‘N/A’ can also be excluded. After the PMA algorithm is configured, the data is loaded (step 320) and analyzed using the configured matching algorithm (step 330).

The comparison function takes data from one or more input fields and produce one or more standardized output values. For examples, the comparison function may remove dashes from social security numbers and/or remove punctuations from the addresses. In some cases, the comparison function take into account misspellings. In some cases, the comparison function assigns a matching value to records. For example, if the two records have completely unmatching values, such as “John” and “Jim”, a matching value of ‘0’ can be assigned. If the two records have completely matching values, such as “John” and “John”, a matching value of ‘1’ can be assigned. If the two records are partially matching, such as “John” and “Jhon”, a matching value between 0 and 1 can be assigned.

The comparison function may use weights to determine the output values. In some cases, a weight is the numerical value representing the likelihood that two records are matching (i.e., referring to the same person). The weight is calculated using probabilistic analysis based on weights attached to each data field in the person index. These weights are then added together to come up with a weighted score or threshold value. If the field contents of two records are identical then they are given an agreement weight defined for that field. The agreement weight is based on how likely the fields are identical, based on random chance. The more like a random identical match, the lower the agreement weight. If the field contents of two records do not match identically then they are given a disagreement weight for that field. The disagreement weight is based on the reliability of that field. Reliability is the likelihood that the field contents of two records from the matched set are identical. The more reliable a field, the stronger (more negative) the disagreement weight.

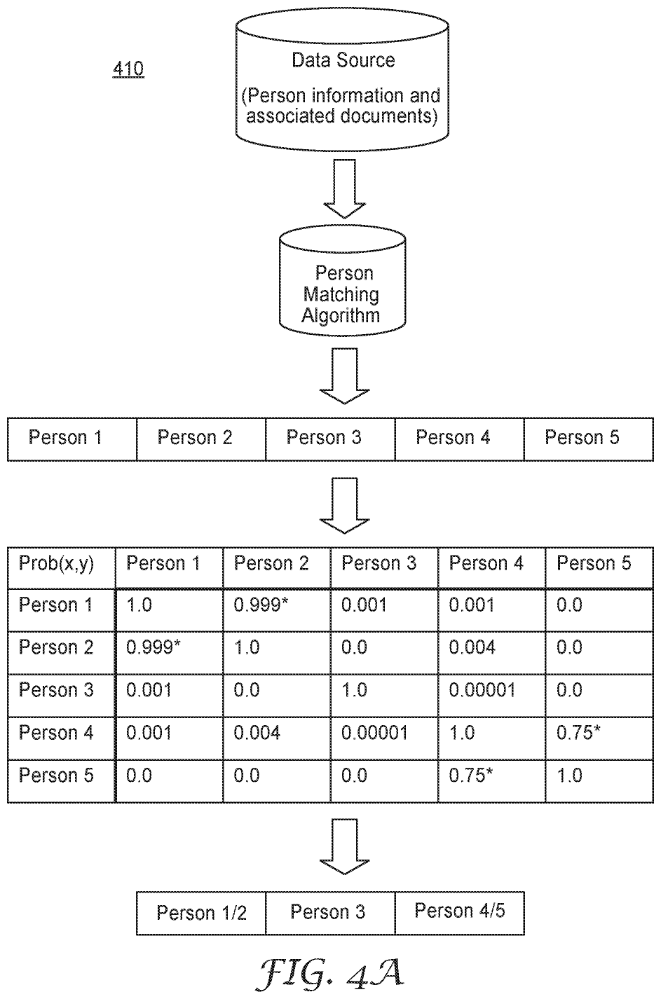

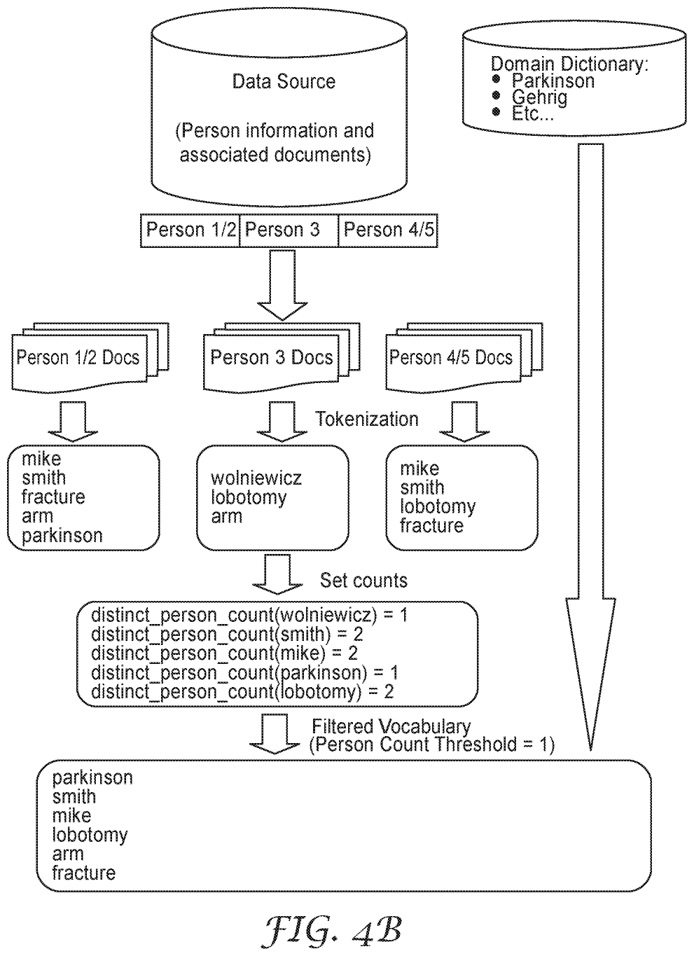

FIGS. 4A and 4B illustrate one example of a word filtering system with some example data. In the embodiment illustrated, the word filtering system is to remove personal identifiable information. First, an occurrence threshold is set to T. In some cases, no tokens which occur in fewer than T person documents will be used to generate a language model. The system initializes V to an initial set of known valid tokens, for example, tokens appearing in a domain dictionary. The system applies PMA to identify documents of the same persons. In some cases, each data source may have a specific PMA. The system will apply the specific PMA to the data source.

In one embodiment, the system uses the PMA to compute a P×P match matrix M where M(x,y)=1 if there is high possibility that persons x and y are the same; M(x,y)=0 if the PMA determines there is essentially no possibility x and y are the same person; and M(x,y)=m, where m is between 0 and 1 based on the matching possibility. Next, uses the matrix M to find matching persons. In the example, person 1 and person 2 are matching and person 4 and person 5 are matching.

In one embodiment, for each person P, the system perform the following steps: tokenize all documents associated with this person P; combine all document tokens into the set of distinct tokens, also called “bags of words”; add each token this does not exist in V to a candidate token set C; for each token in C, determine whether it appears in at least T person-distinct token sets, if so, add it to the set of valid tokens V. In one example, the system can compute a language model, for example, a distributed word representation model, across all documents but only for tokens in the final set V.

Table 1 lists the pseudo code for an embodiment of a word filtering system.

TABLE 1
Pseudo Code for an embodiment of a Word Filter System

Set identifiable person threshold T
Initialize the set of filtered tokens V to an initial set of known valid tokens - e.g. tokens appearing
in a domain dictionary.
For each data subset D from a data source which has a distinct Person Matching Algorithm PMA:

Apply PMA to determine a set of persons P where known matches (same established ID or
other positive PMA match) have been resolved.
Use the PMA to compute a PxP match matrix M where M(x,y) = 1 if there is some
possibility that persons x and y are the same. M(x,y) = 0 if the PMA determines there is
essentially no possibility x and y are the same patient.
Set the matching threshold to be 0.5.
Identify each person P.
Then for each person P:

Tokenize all documents associated with this person P.
Combine all document tokens into the set of distinct tokens in these tokens
Tokens which already exist in V (domain dictionary terms) can be ignored as a
performance optimization.
Add each token to a candidate vocabulary set C.
For each token in C, determine whether it appears in at least T person-distinct
token sets. If so, add it to the set of filtered tokens V.

### Examples

An example of the use of a word filtering system is described below. In this example, a data source containing over 1,000,000 individual records was used. A PMA was used to compute the probability that any two persons in the data source were in fact the same person. A correlation matrix was computed from the associated identifiers and is shown in FIG. 4A for five example persons. In some examples, a threshold of 0.1 or less might be used to be very conservative in catching possible person matches, and a person count threshold of 10 or more would be used to ensure terms aren't patient identifiers. By using a conservatively low matching value of 0.5, it was determined that persons 1&2 were possibly the same, and persons 4&5 were possibly the same. With this information, the data records for the matching persons were combined.

In the next step, the associated documents for the matched persons above were extracted from the data source and scanned to identify all potentially relevant personal and medical terms. Any terms that are already contained within the associated domain dictionary were ignored. The scanning resulted in the identification of 5 tokens for Person 1/2, 3 tokens for Person 3, and 4 tokens for Person 4/5 as shown in FIG. 4B. The word count for each token was computed, and any tokens above the Person Count Threshold of 1 represented records that are free of identifiable data, and were passed out of the algorithm for further downstream processing.

### Exemplary Embodiments

Item A1. A method of word filtering implemented on a system having one or more processors and memories, comprising: receiving a plurality of documents; receiving a domain dictionary; generating, by the one or more processors, a set of tokens for each of the plurality of documents, each token representing a meaningful segment in the document; separating, by the one or more processors, the set of tokens into a subset of dictionary tokens and a subset of non-dictionary tokens, wherein each of the subset of dictionary tokens is in the domain dictionary, and wherein each of the subset of non-dictionary tokens is not in the domain dictionary; filtering, by the one or more processors, the subset of non-dictionary tokens to produce a subset of filtered non-dictionary tokens, wherein each of the filtered non-dictionary tokens has an occurrence frequency greater than a predefined threshold; and generating, by the one or more processors, a set of filtered tokens, wherein the set of filtered tokens comprises the subset of dictionary tokens and the subset of filtered non-dictionary tokens.

Item A2. The method of Item A1, further comprising: identifying, by the one or more processors, a source of each of the plurality of documents.

Item A3. The method of Item A2, wherein the identifying step comprises employing a matching algorithm to identify the source of each document.

Item A4. The method of Item A3, wherein the matching algorithm comprises a person matching algorithm.

Item A5. The method of Item A2, wherein the occurrence frequency is determined based on source-distinct documents.

Item A6. The method of Item A5, wherein two source-distinct documents have different sources from each other.

Item A7. The method of Item A5, wherein the occurrence frequency of a token is determined to be based on a number of source-distinct documents having the token.

Item A8. The method of any one of Items A1-A7, further comprising: generating, by the one or more processors, a language model using the set of filtered tokens.

Item A9. The method of Item A8, wherein the language model comprises at least one of a word embedding model, a word representation model, a statistical language model, a unigram language model, an n-gram model.

Item A10. The method of any one of Items A1-A9, wherein the domain dictionary is a health data dictionary.

Item A11. The method of Item A10, wherein the plurality of documents comprise a plurality of medical documents.

Item B1. A system having one or more processors and memories for word filtering, comprising: the one or more memories configured to store a plurality of document; and store a domain dictionary; the one or more processors configured to: generate a set of tokens for each of the plurality of documents, each token representing a meaningful segment in the document; separate the set of tokens into a subset of dictionary tokens and a subset of non-dictionary tokens, wherein each of the subset of dictionary tokens is in the domain dictionary, and wherein each of the subset of non-dictionary tokens is not in the domain dictionary; filter the subset of non-dictionary tokens to produce a subset of filtered non-dictionary tokens, wherein each of the filtered non-dictionary tokens has an occurrence frequency greater than a predefined threshold; and generate a set of filtered tokens, wherein the set of filtered tokens comprises the subset of dictionary tokens and the subset of filtered non-dictionary tokens.

Item B2. The system of Item B1, wherein the one or more processors are further configured to:

identify a source of each of the plurality of documents.

Item B3. The system of Item B2, wherein the one or more processors are further configured employ a matching algorithm to identify the source of each document.

Item B4. The system of Item B3, wherein the matching algorithm comprises a person matching algorithm.

Item B5. The system of Item B2, wherein the occurrence frequency is determined based on source-distinct documents.

Item B6. The system of Item B5, wherein two source-distinct documents have different sources from each other.

Item B7. The system of Item B5, wherein the occurrence frequency of a token is determined to be based on a number of source-distinct documents having the token.

Item B8. The system of any one of Items B1-B7, wherein the one or more processors are further configured to generate a language model using the set of filtered tokens.

Item B9. The system of Item B8, wherein the language model comprises at least one of a word embedding model, a word representation model, a statistical language model, a unigram language model, an n-gram model.

Item B10. The system of any one of Items B1-B9, wherein the domain dictionary is a health data dictionary.

Item B11. The system of Item B10, wherein the plurality of documents comprise a plurality of medical documents.

The present invention should not be considered limited to the particular examples and embodiments described above, as such embodiments are described in detail to facilitate explanation of various aspects of the invention. Rather the present invention should be understood to cover all aspects of the invention, including various modifications, equivalent processes, and alternative devices falling within the spirit and scope of the invention as defined by the appended claims and their equivalents.

What is claimed is:

1. A method of word filtering implemented on a system having one or more processors and memories, comprising:
receiving a plurality of documents;
receiving a domain dictionary;
generating, by the one or more processors, a set of tokens for each of the plurality of documents, each token representing a meaningful segment in the document;
separating, by the one or more processors, the set of tokens into a subset of dictionary tokens and a subset of non-dictionary tokens, wherein each of the subset of dictionary tokens is in the domain dictionary, and wherein each of the subset of non-dictionary tokens is not in the domain dictionary;
filtering, by the one or more processors, the subset of non-dictionary tokens to produce a subset of filtered non-dictionary tokens, wherein each of the filtered non-dictionary tokens has an occurrence frequency greater than a predefined threshold; and
generating, by the one or more processors, a set of filtered tokens, wherein the set of filtered tokens comprises the subset of dictionary tokens and the subset of filtered non-dictionary tokens.

2. The method of claim 1, further comprising:
identifying, by the one or more processors, a source of each of the plurality of documents.

3. The method of claim 2, wherein the identifying step comprises employing a matching algorithm to identify the source of each document.

4. The method of claim 3, wherein the matching algorithm comprises a person matching algorithm.

5. The method of claim 2, wherein the occurrence frequency is determined based on source-distinct documents.

6. The method of claim 5, wherein two source-distinct documents have different sources from each other.

7. The method of claim 5, wherein the occurrence frequency of a token is determined to be based on a number of source-distinct documents having the token.

8. The method of claim 1, further comprising:
generating, by the one or more processors, a language model using the set of filtered tokens.

9. A system having one or more processors and memories for word filtering, comprising:
the one or more memories configured to
store a plurality of documents; and
store a domain dictionary;
the one or more processors configured to:
generate a set of tokens for each of the plurality of documents, each token representing a meaningful segment in the document;
separate the set of tokens into a subset of dictionary tokens and a subset of non-dictionary tokens, wherein each of the subset of dictionary tokens is in the domain dictionary, and wherein each of the subset of non-dictionary tokens is not in the domain dictionary;
filter the subset of non-dictionary tokens to produce a subset of filtered non-dictionary tokens, wherein each of the filtered non-dictionary tokens has an occurrence frequency greater than a predefined threshold; and
generate a set of filtered tokens, wherein the set of filtered tokens comprises the subset of dictionary tokens and the subset of filtered non-dictionary tokens.

10. The system of claim 9, wherein the one or more processors are further configured to:
identify a source of each of the plurality of documents.

11. The system of claim 10, wherein the one or more processors are further configured employ a matching algorithm to identify the source of each document.

12. The system of claim 11, wherein the matching algorithm comprises a person matching algorithm.

13. The system of claim 10, wherein the occurrence frequency is determined based on source-distinct documents.

14. The system of claim 13, wherein two source-distinct documents have different sources from each other.

15. The system of claim 14, wherein the occurrence frequency of a token is determined to be based on a number of source-distinct documents having the token.
